(19) United States
(12) Patent Application Publication
(10) Pub. No.: US 2008/0318569 A1
(43) Pub. Date: Dec. 25, 2008

(54) Call delivery system to reach displaced wireless users after a regional disaster

(76) Inventors: John J. MacNamara, Orland Park, IL (US); Joseph E. Seitz, Naperville, IL (US); Robin J. Thompson, Batavia, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/820,924

(22) Filed: Jun. 21, 2007

(51) Int. Cl. H04Q 7/34

(52) U.S. Cl. 455/433

(57) ABSTRACT

An apparatus and method are provided for a call delivery system capable of reaching displaced wireless users after a natural disaster. A calling party may call a publicized general reach number, e.g., 800 number, to contact a wireless user. The home mobile switching center (MSC) of the wireless user may be damaged, inoperable or overloaded, thus prohibiting incoming calls for the wireless user. Upon being connected to the general reach number, the calling party may be prompted to provide a destination number for the wireless user. Upon receiving the destination number, a home location register may be queried to retrieve a temporary local directory number (TLDN) for the wireless user while bypassing the home MSC of the wireless user. Upon receiving the TLDN, an incoming call from the calling party may be delivered to a last MSC visited by the wireless user.

### TECHNICAL FIELD

This invention relates to the art of wireless communications, and more particularly to a technique for routing calls to wireless communications devices when the home mobile switching center is inoperable.

### BACKGROUND

After a natural disaster, e.g., hurricane, flood, wildfire, earthquake, etc., many people may be displaced across the country. Illustratively, after hurricane Katrina, many of the residents of New Orleans were relocated to Houston. Many of the people affected by natural disasters may own cellular or other types of wireless communications devices. The displaced wireless users may be able to originate wireless calls and Short Message Service (SMS) services, because the calls originated by the wireless users are routed by a current, i.e., visited, mobile switching center (MSC), e.g., Houston. Disadvantageously, the displaced wireless users may be unable to receive incoming calls to their wireless communications devices, because incoming calls intended for the displaced wireless users are normally routed to their home MSC, e.g., New Orleans, which is associated with their area code and office code. The home MSC may have become inoperable as a result of the natural disaster or the home MSC may be overloaded. Consequently, the home MSC may be unable to query a home location register (HLR) to determine a last known serving MSC, i.e., visited MSC, of the displaced wireless users and obtain a temporary local directory number (TLDN) or routing number so that the incoming call may be properly delivered.

In one prior art system, a wireless user planning to visit another city would have to tell people wishing to call the wireless user a roamer access port number for that city. Disadvantageously, the people wishing to call the wireless user would have to know a) the city visited by wireless user, and b) the roamer access port number for the city visited by the wireless user.

### SUMMARY

It has been recognized, in accordance with the principles of the invention, that the problems of the prior art can be overcome by a call delivery system capable of reaching displaced wireless users after a natural disaster. More specifically, the present invention provides a method having the steps of a) receiving a call from a calling party, b) prompting the calling party to provide a destination number of a wireless user, c) querying a home location register (HLR) to retrieve a temporary local directory number (TLDN) for the wireless user while bypassing a home mobile switching center (MSC) of the wireless user, and d) delivering an incoming call from the calling party to a last MSC visited by the wireless user based on the TLDN.

Also, the present invention provides an apparatus having a) means for receiving a call from a calling party, b) means for prompting a calling party to provide a destination number of a wireless user, c) means for querying a home location register (HLR) to retrieve a temporary local directory number (TLDN) for the wireless user while bypassing a home mobile switching center (MSC) of the wireless user, and d) means for delivering an incoming call from the calling party to a last MSC visited by the wireless user based on the TLDN.

### DESCRIPTION OF THE DRAWINGS

FIG. 1 shows an illustrative embodiment of a call delivery system to reach displaced wireless users after a natural disaster arranged in accordance with the principles of the invention;

FIG. 2 shows an illustrative embodiment of a Wireless Network Emergency Area Routing System arranged in accordance with the principles of the invention; and

FIG. 3 shows an illustrative flow chart for a method of operating the call delivery system to reach displaced wireless users after a natural disaster arranged in accordance with the principles of the invention.

### DETAILED DESCRIPTION

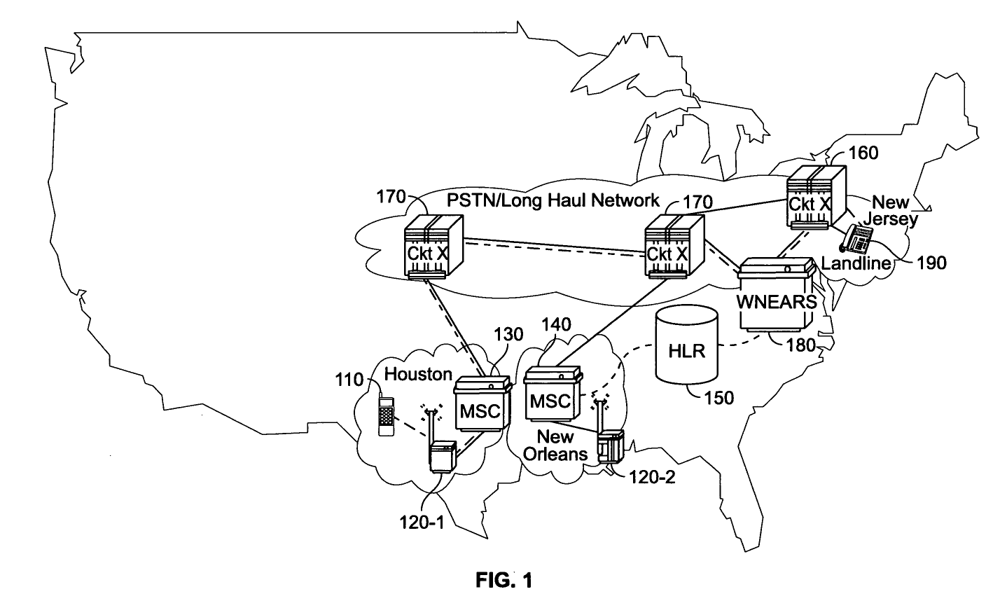

FIG. 1 shows an illustrative embodiment of a call delivery system to reach displaced wireless users after a natural disaster arranged in accordance with the principles of the invention. In FIG. 1, the call delivery system to reach displaced wireless users after a natural disaster 100 shows mobile device 110 which connects to mobile switching center (MSC) 130 via base station 120-1. MSC 140 connects to home location register (HLR) 150 and base station 120-2. MSC 130, MSC 140 and MSC 160 are coupled to Public Switched Telephone Network (PSTN)/long distance network 170. Wireless Network Emergency Area Routing System (WNEARS) 180 has a signaling connection to HLR 150. Also, WNEARS 180 has trunk connections to MSC 160 and PSTN/long distance network 170. Calling party 190 is connected to MSC 160. Base station 120-1 and base station 120-2 are collectively hereinafter base stations 120.

Mobile device 110 is a mobile communications device capable of wirelessly connecting to a communications network, e.g., PSTN/long distance network 170, via a telephone switching network having wireless technologies that may include one or more mobile base stations, e.g., base stations 120, connected to one or more mobile switches, e.g., MSC 130, allowing a user of mobile device 110 to communicate, via a user interface on mobile device 110, with another party, e.g., calling party 190. The user interface of mobile device 110 may include an audio interface, such as a microphone and speakers, a visual interface, such as a display, and a user input interface, such as a keyboard or touch pad.

Mobile device 110 may be operated in a given geographical area which may be a) a visiting area served by a visited MSC, e.g., MSC 130, by which a subscriber roams into or b) the subscriber's home service area served by a home MSC, e.g., MSC 140. Mobile device 110 is capable of sending and receiving voice calls, email, SMS, microbrowser messages or text messaging, etc. Mobile device 110 may use an air interface standard such as Code Division Multiple Access (CDMA), Time Division Multiple Access (TDMA), Universal Mobile Telecommunications System (UMTS), Global System for Mobile Communications (GSM), etc., not shown, or any other standard or protocol which supports voice calls, email, SMS, microbrowser messages or text messaging. Mobile device 110 may be capable of multi-band operation, i.e., two radio access technologies.

In one embodiment of the invention, mobile device 110 may be a small, light-weight portable mobile telephone, e.g., pocket telephone. In another embodiment of the invention, mobile device 110 may be a mobile telephone installed in an engine-driven vehicle and supplied with current from the vehicle electrical system. In an alternative embodiment of the invention, mobile device 110 may be a personal digital assistance (PDA) device, a notebook computer, a two-way pager or other suitable wireless communications devices.

Base stations 120 are radio transmitters/receivers that provide bi-directional wireless connectivity for wireless communication devices, e.g., mobile device 110, within a geographical area, or a cell, i.e., a basic geographic unit of a cellular system, proximate to base stations 120. Base stations 120 may use an air interface standard that is complementary to the air interface standard of mobile device 110 so that calls may be connected from mobile device 110 to a mobile switching center, e.g., MSC 130, which may connect the calls to PSTN/long distance network 170. Base stations 120 may be positioned at or near the center of each cell or, depending on geography and other known factors, base stations 120 may instead be located at or near the periphery of, or otherwise away from the center of, each cell. Base stations 120, and other base stations not shown, may be geographically dispersed to form an area of coverage for a specific MSC. Base stations 120, in one embodiment, comprises one or more of a Flexent® Code Division Multiple Access (CDMA) 450 MHz Modular Base Station (Alcatel-Lucent).

MSC 130, MSC 140 and MSC 160 are telecommunications switches capable of switching calls between a plurality of endpoints via a wireless network connected to the PSTN, e.g., PSTN/long distance network 170. MSC 130, MSC 140 and MSC 160 have call control components, not shown, that monitor all mobile phone calls, e.g., calls from mobile device 110, within their serving area, tracks the location of all mobile phone-equipped vehicles traveling within its service area, arranges handoffs between switches, keeps track of billing information, etc. MSC 130, MSC 140 and MSC 160 are capable of broadcasting pages to mobile phones via base stations, e.g., base stations 120, to alert the mobile phones of a call. MSC 130, MSC 140 and MSC 160, in one embodiment, comprise one or more of a CDMA—Mobile Switching Center (Alcatel-Lucent).

MSC 130, MSC 140 and MSC 160 may each be connected to their own home location register, e.g., HLR 150, which contains profiles of subscribers in a serving area of each MSC. The profiles may contain a record of the names, telephone numbers, address, account status and telephone features subscribed to, etc., of all wireless subscribers that utilize each respective MSC as their home MSC. HLR 150 may generate messages according to a network protocol and process requests to obtain requested information. HLR 150 may be geographically distributed or there may be mated pairs of HLR 150 to ensure survivability.

PSTN/long distance network 170 is a communications network capable of transmitting calls between endpoints. PSTN/long distance network 170 may deliver voice, data, and video services. Also, PSTN/long distance network 170 may operate in the circuit-switched domain and in the packet-based domain.

Wireless Network Emergency Area Routing System (WNEARS) 180 provides a prompt and collect interface to provide a cellular gateway function via two stage dialing. WNEARS 180 may be used to access a HLR in real-time to obtain a temporary local directory number (TLDN) to route an incoming call intended for a wireless user, while avoiding and bypassing the home MSC of the wireless user. In one embodiment of the invention, WNEARS 180 may be used to access a HLR, e.g., HLR 150, while avoiding and bypassing an inoperable or damaged MSC, e.g., MSC 140, or associated trunk facilities affected by a natural disaster. In another embodiment of the invention, WNEARS 180 may be used to access a HLR while avoiding and bypassing an overloaded MSC. In both of the above mentioned embodiments, WNEARS 180 may be geographically removed from the damaged, inoperable or overloaded MSC or associated damaged trunk facilities.

Calling parties may receive a publicized general reach number, e.g., 1 800-REACH-ME, to dial-in and contact wireless users. WNEARS 180 may receive calls routed from the publicized general reach number. WNEARS 180 is capable of receiving calls from a calling party, e.g., calling party 190, to a hunt group, e.g., 800 numbers, and connecting the calling party to a system that prompts the calling party to provide a destination number for a wireless user. Illustratively, WNEARS 180 may prompt calling party 190, “Please say or enter the number of the wireless subscriber?” Calling party 190 may provide the destination number for the wireless user by pressing keys on a telephone key pad to provide a dual tone multi-frequency (DTMF) response or calling party 190 may provide the destination number via a voice response. Illustratively, calling party 190 may provide the destination number “6783462800”, where 678 comprises an area code and 346-2800 comprises a seven digit local phone number in the United States of the wireless subscriber. Also illustratively, the digits “346” comprise the office code, i.e., exchange, of the home MSC of the wireless user. WNEARS 180 may terminate the call to calling party 190 if the area code of the destination number provided by calling party 190 is outside of a designated area code group, e.g., area codes not located within a disaster area.

Upon receipt of the response from calling party 190, WNEARS 180 collects the digits, performs a digit analysis to identify an appropriate HLR based on the digits, and populates a query to the HLR, e.g., HLR 150, to obtain the TLDN for the wireless user. The TLDN is a fully network routable number with area code, office code, etc. Consequently, WNEARS 180 may use the TLDN to determine the next switch in the routing path to deliver the call from calling party 190.

WNEARS 180 may be able to determine an air interface standard, e.g., CDMA, GSM, TDMA, UMTS, etc., for the HLR query based on the destination number of the wireless user provided by calling party 190, thus allowing WNEARS 180 to accommodate queries to wireless users from multiple service providers having different air interface standards or a single service provider that utilizes multiple air interface standards. If WNEARS 180 must support calls to wireless users from multiple service providers, then both ANSI-41 (LocationRequest) and GSM Mobile Application Part (MAP) (SendRoutingInfo) HLR queries must be supported. The query to the HLR must be routed to the correct HLR, e.g., HLR 150, based on a global title translation on the called party number. This global title translation would have to provide “number to HLR mapping” for all wireless users in the affected area. The query to HLR 150 avoids and bypasses the home MSC, e.g., MSC 140, of the wireless user.

Upon receipt of the query from WNEARS 180, HLR 150 retrieves a routing number, i.e., TLDN, from a last MSC visited, e.g., MSC 130, where the wireless user is currently located, provided the wireless user's phone, e.g., mobile device 110, has been turned on previously and allowed to autonomously register with visited MSC 130. MSC 130 may assign and forward a TLDN to HLR 150, which forwards the TLDN to WNEARS 180.

Upon receipt of the response from HLR 150, WNEARS 180 performs translations on the TLDN to obtain an area code of the last MSC visited, e.g., MSC 130, by the wireless user. Next, WNEARS 180 delivers the incoming call from calling party 190 via PSTN/long distance network 170 to MSC 130. Upon arrival of the call, MSC 130 pages mobile device 110 via base station 120-1. If mobile device 110 is on and in the serving area of MSC 130, then the user of mobile device 110 may respond and the call may be set up.

WNEARS 180 may have Signaling System 7 (SS7) interfaces to one or more HLRs in the United States. Thus, WNEARS 180 need not know that a particular switch has become inoperable or overloaded because WNEARS 180 may be able to bypass any MSC to access any HLR. WNEARS 180 may have a look up table, not shown, that denies calls to certain area codes or accepts calls for only particular area codes. The table may be updated by an administrator. Also, WNEARS 180 may have trunk interfaces to PSTN/long distance network 170 and other switches in a network.

In one embodiment of the invention, WNEARS 180 may be provided by a wireless Service Provider as a service to its subscribers. In another embodiment of the invention, WNEARS 180 may be provided by the government or an industry conglomerate as a disaster preparedness solution in a few locations around the country. In yet another embodiment of the invention, WNEARS 180 may be provided by an independent service provider that charges callers for a service, similar to prepaid calling cards or 900 numbers.

Those of ordinary skill in the art will readily be able to select MSCs, HLRs, base stations and Wireless Network Emergency Area Routing Systems appropriate for use in any particular implementation of the call delivery system to reach displaced wireless users after a natural disaster.

Advantageously, displaced wireless users may be able to receive incoming calls to their wireless communications devices after a disaster because inoperable switches may be avoided and bypassed. Also advantageously, calling parties attempting to contact displaced wireless users need not know a) the city visited by displaced wireless user or b) the roamer access port number for the city visited by the displaced wireless user. Further advantageously, the use of the Wireless Network Emergency Area Routing System avoids the time and cost of immediately adding new switches to a network after a disaster. Thus, thousands of changes to network routing tables that result from the addition of new switches to a network may be avoided.

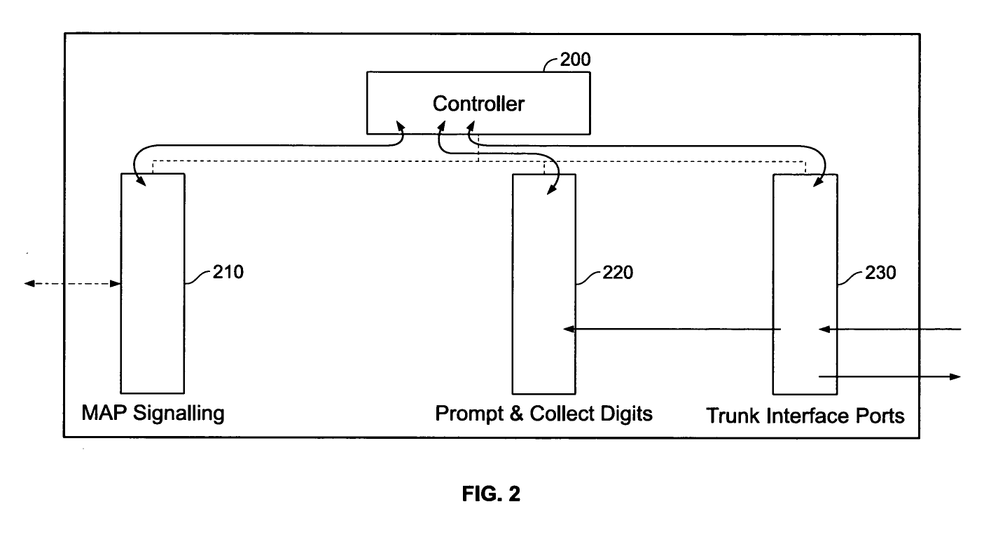

FIG. 2 shows an illustrative embodiment of a Wireless Network Emergency Area Routing System arranged in accordance with the principles of the invention. The various elements depicted in FIG. 2 may be implemented using any combination of hardware, software, or firmware using known techniques in accordance with the teachings herein. Also, the various elements illustrate an exemplary configuration and partition of functions. Furthermore, the various elements may be implemented in a centralized manner having all of the elements within a single physical device, or in a distributed manner in which the various elements are housed in separate physical devices. As shown in FIG. 2, Controller 200 is connected to MAP Signaling component 210, Prompt & Collect Digits component 220 and Trunk Interface Ports 230.

Controller 200 manages functions and data used by MAP Signaling component 210, Prompt & Collect Digits component 220 and Trunk Interface Ports 230. Controller 200 directs the activities of Prompt & Collect Digits component 220 that are based on policy, rather than on protocol specifications. Illustratively, Controller 200 may direct a failure announcement to be played to callers attempting to connect to an area code or mobile phone number which is not supported by the system.

MAP Signaling component 210 manages the signaling messages to and from HLRs. MAP Signaling component 210 determines air interface standards based on the destination number provided by the calling party, performs protocol translations, queries HLRs, receives TLDNs from the HLRs and performs translations on the TLDNs to obtain an area code for the last visited MSC of the wireless user.

Prompt & Collect Digits component 220 manages communications received from calling parties. Upon being connected to a calling party, Prompt & Collect Digits component 220 may ask the calling party, via a human sounding automated voice, to provide the destination number for the wireless subscriber. The response to this question may be answered by either a voice response or by pressing keys on the key pad of a telephone. In one embodiment of the invention, Prompt & Collect Digits component 220 may use voice recognition to determine when the calling party has completed the voice response. Prompt & Collect Digits component 220 collects the digits delivered by Trunk Interface Ports 230 from the calling party, and performs a digit analysis to identify an appropriate HLR based on the digits. Prompt & Collect Digits component 220 may have a digit analysis table, not shown, which maps telephone numbers to HLRs.

Trunk Interface Ports 230 manages the media stream from calling parties. Specifically, Trunk Interface Ports 230 notifies Controller 200 upon receipt of a call from a calling party, delivers the destination number of the wireless user to Prompt & Collect Digits component 220 from the calling party, and delivers the incoming call from the calling party to PSTN/long distance network 170 upon receipt of the TLDN from the HLR.

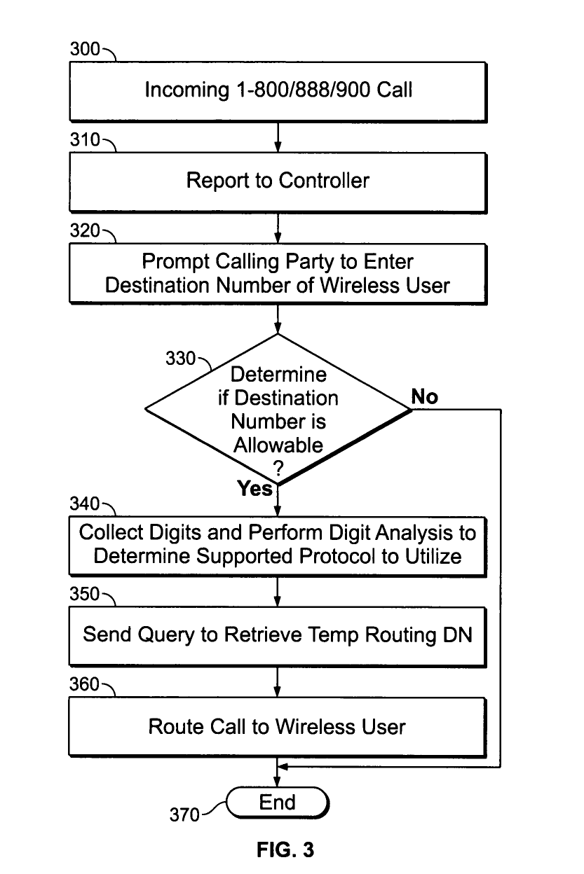

FIG. 3 shows a flow chart of the operation of the call delivery system to reach displaced wireless users after a natural disaster arranged in accordance with the principles of the invention. The process is entered in step 300 when Trunk Interface Ports 230 (FIG. 2) of WNEARS 180 (FIG. 1) receives a call from a calling party, e.g., calling party 190, attempting to contact a wireless user.

In step 310 (FIG. 3), Trunk Interface Ports 230 (FIG. 2) notifies Controller 200 of the call.

In step 320 (FIG. 3), Controller 200 (FIG. 2) directs Prompt & Collect Digits component 220 to prompt calling party 190 (FIG. 1) to provide the destination number of the wireless user. Calling party 190 may respond by pressing the keys on a telephone key pad or with a voice response.

In step 330 (FIG. 3), it is necessary for Controller 200 (FIG. 2) to determine whether the destination number is allowable.

If the test result in conditional branch point 330 (FIG. 3) is NO, indicating that the area code of the destination number provided by calling party 190 is outside of a designated area code group, then control is passed to step 370 (FIG. 3). If the test result in step 330 is YES, indicating that the area code of the destination number provided by calling party 190 is allowed, then control is passed to step 340.

In step 340 (FIG. 3), Controller 200 (FIG. 2) directs Prompt & Collect Digits component 220 to collect the digits delivered by Trunk Interface Ports 230 from calling party 190. Also, Controller 200 directs Prompt & Collect Digits component 220 to perform a digit analysis to identify an appropriate HLR to query based on the digits.

In step 350 (FIG. 3), Controller 200 (FIG. 2) directs MAP Signaling component 210 to determine the appropriate protocol for the query, perform protocol translations based on the destination number provided by the calling party and query HLR 150 (FIG. 1) for a TLDN. Upon receipt of the TLDN from HLR 150, MAP Signaling component 210 (FIG. 2) performs translations on the TLDN to obtain an area code for the last visited MSC, e.g., MSC 130 (FIG. 1), of the wireless user.

In step 360 (FIG. 3), Controller 200 (FIG. 2) directs Trunk Interface Ports 230 to deliver the incoming call from calling party 190 to the wireless user via PSTN/long distance network 170 (FIG. 1) based on the TLDN.

The process is exited in step 370.

In practice, telecommunications system processes are implemented in computer software using high-performance processors and high-capacity storage elements such as hard disk subsystems. The computer program code that implements particular telecommunications system functions is stored on computer-readable media, such as the hard disk system, and executed by the processor.

The steps or operations described herein are intended as examples. There may be many variations to these steps or operations without departing from the spirit of the invention. For instance, the steps may be performed in a different order, or steps may be added, deleted, or modified.

The foregoing merely illustrates the embodiments of the invention. It will thus be appreciated that those skilled in the art will be able to devise various arrangements, which, although not explicitly described or shown herein, embody the principles of the invention, and are included within its spirit and scope.

What is claimed:

1. A method, comprising the steps of:
receiving a call from a calling party;
prompting the calling party to provide a destination number of a wireless user;
querying a home location register (HLR) to retrieve a temporary local directory number (TLDN) for the wireless user while bypassing a home mobile switching center (MSC) of the wireless user; and
delivering an incoming call from the calling party to a last MSC visited by the wireless user based on the TLDN.

2. The method of claim 1 further comprising the step of collecting the digits of the destination number upon receipt of a response from the calling party.

3. The method of claim 2 wherein the collecting step further comprising the step of collecting a dual tone multi-frequency (DTMF) response or a voice response.

4. The method of claim 1 further comprising the step of identifying the HLR based on the destination number of the wireless user.

5. The method of claim 4 further comprising the step of performing a global title translation to identify the HLR.

6. The method of claim 1 further comprising the step of determining an air interface standard for the querying step based on the destination number of the wireless user.

7. The method of claim 6 wherein the air interface standard is at least one of Code Division Multiple Access (CDMA), Time Division Multiple Access (TDMA), Universal Mobile Telecommunications System (UMTS) and Global System for Mobile Communications (GSM).

8. The method of claim 6 further comprising the step of translating the TLDN to obtain an area code of the last MSC visited by the wireless user.

9. The method of claim 1 wherein the querying step further comprises the step of querying the HLR via ANSI-41 (LocationRequest) queries.

10. The method of claim 1 wherein the querying step further comprises the step of querying the HLR via GSM MAP (SendRoutingInfo) queries.

11. The method of claim 1 further comprising the step of terminating the call to the calling party if the area code of the destination number is outside of a designated area code group.

12. An apparatus, comprising:
means for receiving a call from a calling party;
means for prompting the calling party to provide a destination number of a wireless user;
means for querying a home location register (HLR) to retrieve a temporary local directory number (TLDN) for the wireless user while bypassing a home mobile switching center (MSC) of the wireless user; and
means for delivering an incoming call from the calling party to a last MSC visited by the wireless user based on the TLDN.

13. The apparatus of claim 12 further comprising means for collecting the digits of the destination number upon receipt of a response from the calling party.

14. The apparatus of claim 13 wherein the means for collecting further comprises means for collecting a dual tone multi-frequency (DTMF) response or a voice response.

15. The apparatus of claim 12 further comprising means for identifying the HLR based on the destination number of the wireless user.

16. The apparatus of claim 15 further comprising means for performing a global title translation to identify the HLR.

17. The apparatus of claim 12 further comprising means for determining an air interface standard for the querying step based on the destination number of the wireless user.

18. The apparatus of claim 17 wherein the air interface standard is at least one of Code Division Multiple Access (CDMA), Time Division Multiple Access (TDMA), Universal Mobile Telecommunications System (UMTS) and Global System for Mobile Communications (GSM).

19. The apparatus of claim 17 further comprising means for translating the TLDN to obtain an area code of the last MSC visited by the wireless user.

20. The apparatus of claim 12 further comprising means for querying the HLR via ANSI-41 (LocationRequest) queries.

21. The apparatus of claim 12 further comprising means for querying the HLR via GSM MAP (SendRoutingInfo) queries.

22. The apparatus of claim 12 further comprising means for terminating the call to the calling party if the area code of the destination number is outside of a designated area code group.

23. An apparatus operable to deliver a call from a calling party to a user of a wireless communications device based on a temporary local directory number obtained from a home location register (HLR) upon bypassing a mobile switching center.

24. The apparatus of claim 23 further comprising:
a controller;
a signaling component connected to the controller, the signaling component being operable to manage signaling messages to and from the HLR;
a digit collection component connected to the controller, the digit collection component being operable to manage communications received from the calling party; and
a trunk interface connected to the controller, the trunk interface being operable to connect the call to a long distance network for delivery to the user.
